(19) United States
(12) Patent Application Publication
(10) Pub. No.: US 2010/0079701 A1
(43) Pub. Date: Apr. 1, 2010

(54) LENS SHEET, SURFACE LIGHT SOURCE DEVICE, AND LIQUID CRYSTAL DISPLAY DEVICE

(76) Inventors: Yoshiaki Murayama, Kanagawa (JP); Osamu Numata, Kanagawa (JP)

Correspondence Address: MORGAN LEWIS & BOCKIUS LLP, 1111 PENNSYLVANIA AVENUE NW, WASHINGTON, DC, 20004, US

(21) Appl. No.: 12/518,134

(22) PCT Filed: Dec. 7, 2007
(86) PCT No.: PCT/JP2007/073715

§ 371 Date: Jun. 8, 2009

(30) Foreign Application Priority Data
Dec. 8, 2006 (JP) 2006-332357
Jan. 12, 2007 (JP) 2007-005116

(51) Int. Cl. G02F 1/13357; G02B 5/02; G09F 13/04

(52) U.S. Cl. 349/64; 359/599; 362/97.1

(57) ABSTRACT

In a prism sheet (4), a plurality of prism rows (411) are formed in parallel on a first surface of a sheet-like translucent base material (43), and a light diffusion layer (45) containing light diffusing materials (452, 454) in a translucent resin (451) is formed on a second surface. The ratio of internal haze to the total haze of the light diffusion layer (45) is 20-90%, and a content rate of the light diffusion material having a particle diameter of 1-4 μm to the total quantity of the light diffusion materials (452, 454) is 50 vol % or more.

### TECHNICAL FIELD

The present invention relates to a liquid crystal display device, a surface light source device which is used as a backlight of the liquid crystal display device, and a lens sheet which constitutes the surface light source device. In particular, the present invention relates to a lens sheet, a surface light source device, and a liquid crystal display device which are intended to reduce a glare phenomenon called speckles or sparkling of image display on the liquid crystal display device without a drop in luminance.

### BACKGROUND ART

In recent years, color liquid crystal display devices have been widely used in a variety of fields as the image display means of monitors of portable notebook PCs or desktop PC, portable TVs, video-TV hybrid systems, etc. The liquid crystal display elements (liquid crystal panels) used in such liquid crystal display devices do not emit light by themselves but function as an optical shutter. To improve the image display performance of a liquid crystal display device, it has thus been common practice to provide a surface light source device called backlight behind a liquid crystal panel so that the liquid crystal panel is illuminated from the back side with light that is emitted from the surface light source device.

For example, as described in JP-A-02-084618 (Patent Document 1) and JP-U-03-069184 (Patent Document 2), such a backlight is composed of: a fluorescent tube as a primary light source; a light guide; a reflecting sheet; and a lens sheet as a light deflecting element, such as a prism sheet. Of these, the prism sheet is arranged over the light emission surface of the light guide so as to improve the optical efficiency of the backlight for enhanced luminance. One example is a lens sheet that is formed by arranging elongated prisms, each having an isosceles triangular section with a vertex angle of 60° to 100°, in parallel with the pitch of 50 μm on one of the surfaces of a transparent sheet.

As described in JP-A-06-324205 (Patent Document 3), JP-A-10-160914 (Patent Document 4), and JP-A-2000-353413 (Patent Document 5), it has been proposed to equip a prism sheet with a surface structure having a light diffusing function on the side opposite from a surface where elongated prisms are formed, so as to provide the function of a light diffusion sheet or light diffusion film. In the prism sheet of Patent Document 3, a group of projections having a light diffusing function, with a height of greater than or equal to the wavelength of the source light and lower than or equal to 100 μm, are formed to improve the luminance and reduce luminance variations of the surface light source device. In the prism sheet of Patent Document 4, a light diffusion layer of coating type, emboss type, or sandblast type is formed to improve the luminance and increase the viewing angle in the surface light source device. In the prism sheet of Patent Document 5, a layer of light diffusing fine particles such as transparent beads is applied for improved luminance and increased viewing angle.

Patent Document 1: JP-A-02-084618

Patent Document 2: JP-U-03-069184

Patent Document 3: JP-A-06-324205

Patent Document 4: JP-A-10-160914

Patent Document 5: JP-A-2000-353413

### DISCLOSURE OF THE INVENTION

### Problems to be Solved by the Invention

One of the functions of the foregoing surface structure of the prism sheet with the light diffusing function is to diffuse light by each individual projection so that a desired haze is developed to make intended adjustments in luminance and viewing angle. Another function of the surface structure of the prism sheet with the light diffusing function is to suppress a phenomenon called sticking, in which the prism sheet locally comes into close contact with a light diffusion sheet or liquid crystal panel lying on its top surface (on the surface opposite from the elongated prism formed surface) to produce an interference pattern. Yet another function of the surface structure of the prism sheet with the light diffusing function is what is called hiding or masking or opacifying, which is to reduce the visibility of defects in the surface structure of the elongated prism and reduce the visibility of defects in such surface structures as a mat structure and an elongated prism formed structure formed on the light emission surface of the light guide or the opposite back surface thereof. The defect hiding increases in significance particularly when a high-intensity light source is used as the primary light source.

Now, if the surface structure having a light diffusing function is formed on a side of the prism sheet opposite from the elongated prism formed surface, the light that is emitted from the light guide and internally reflected by the elongated prisms on the prism sheet with extremely high directionality can sometimes interfere with the surface structure having the light diffusing function. This can cause a glare phenomenon called speckles or sparkling in which fine particles inside the coating film and irregularities on the surface produce intense glare. In such a case, the display image becomes extremely hard to view, and it has thus been strongly demanded recently to solve the glare phenomenon. The foregoing Patent Documents 3 to 5 contain no suggestion about the technical challenge of resolving or reducing such a glare phenomenon.

The glare phenomenon resulting from the surface structure with the foregoing light diffusing function can be suppressed by increasing the amount of addition of the fine particles to the coating film that forms the surface structure, so as to enhance the light diffusing capability. This can reduce the glare phenomenon to some extent, but with the drawback that the luminance of the surface light source device or the liquid crystal display device drops significantly.

Light diffusion layers containing only a single light diffusing agent have also had the drawback that the coating can easily result in an uneven distribution of particles and aggregation of particles, with noticeable defects such as coating stripes. Moreover, when a prism sheet is used in the backlight of a portable notebook PC or portable TV, vibrations during carrying can cause friction between the liquid crystal panel and the light diffusion layer, damaging the light diffusion layer with the problem of defects occurring in the display image of the liquid crystal display device.

Liquid crystal panels have various configurations as to the surface at the side of the light diffusion layer of the prism sheet, depending on the specifications of the liquid crystal display devices. Examples include one having a fine asperity structure for antiglare purpose, one having a smooth surface with no irregular structure, and one surfaced with a multilayer polarizing mirror film such as DBEF from Sumitomo 3M Limited. If the surface having a fine asperity structure for antiglare purpose comes into contact or friction with the light diffusion layer of a prism sheet, it is likely for the light diffusion layer to be damaged since the antiglare layer has high hardness. If a liquid crystal panel has a smooth surface with no irregularities or has a multilayer polarizing mirror film, the light diffusion layer of the prism sheet can in turn damage those surfaces. It has thus been desired for the light diffusion layer of a prism sheet to prevent damage due to contact or friction with such various types of liquid crystal panel surfaces.

It is thus an object of the present invention to reduce the glare phenomenon of a liquid crystal display device without a significant drop in the luminance of the surface light source device or the liquid crystal display device, and to provide a lens sheet that has a light diffusion layer of favorable appearance. Another object of the present invention is to reduce damage to the light diffusion layer because of vibrations in such occasions as carrying the liquid crystal display device, thereby preventing defects of images displayed on the liquid crystal display device.

### Means for Solving the Problems

To achieve the foregoing objects, the present invention provides a lens sheet including a sheet-like transparent base that has a first surface and a second surface, a plurality of elongated lenses being formed in parallel on the first surface, a light diffusion layer made of transparent resin containing a light diffusing agent being formed on the second surface,

wherein the ratio of internal haze to total haze of the light diffusion layer is 20% to 90%, and the ratio of the amount of the light diffusing agent having particle sizes of 1 to 4 μm is 50% or higher by volume with respect to the total amount of the light diffusing agent.

In one aspect of the present invention, a first light diffusing agent that has a difference in refractive index Δn1 of greater than or equal to 0.03 and smaller than or equal to 0.10 from the transparent resin is contained as the light diffusing agent. In one aspect of the present invention, the transparent resin and the first light diffusing agent are an acrylic resin and fine particles of a silicone resin, respectively. In one aspect of the present invention, the ratio of the amount of the first light diffusing agent is 50% or higher by volume with respect to the total amount of light diffusing agents contained in the light diffusion layer. In one aspect of the present invention, a second light diffusing agent that has a difference in refractive index Δn2 of greater than or equal to 0.00 and lower than 0.03 of lower than 0.03 from the transparent resin and has particle sizes of 1 to 6 μm is contained as the light diffusing agent. In one aspect of the present invention, a third light diffusing agent that has particle sizes of 7 to 30 μm is contained as the light diffusing agent. In one aspect of the present invention, the third light diffusing agent forms a protruding structure on the surface of the light diffusion layer, and the protruding structure protrudes in the range of 3 to 25 μm from a reference surface of the light diffusion layer. In one aspect of the present invention, the total haze of the light diffusion layer is 50% to 85%. In one aspect of the present invention, the surface of the light diffusion layer is formed as an irregular surface, and the irregular surface has an average distance between local peaks S of 40 μm or less and has a ten-point average roughness Rz of 4.0 μm or less.

To achieve the foregoing objects, the present invention also provides a surface light source device comprising:

a primary light source;

a light guide that lets in, guides, and emits light emitted from the primary light source; and

the foregoing lens sheet that is arranged so that the light emitted from the light guide is incident thereon,

wherein the light guide has a light incident end surface for the light emitted from the primary light source to be incident on and a light emission surface for the guided light to be emitted from, the primary light source is arranged adjacent to the light incident end surface of the light guide, and the lens sheet is arranged so that the first surface faces the light emission surface of the light guide.

The present invention further provides a liquid crystal display device comprising:

the foregoing surface light source device; and

a liquid crystal panel that is arranged so that light emitted from the second surface of the lens sheet of the surface light source device is incident thereon,

wherein the liquid crystal panel has an incident surface for the light emitted from the second surface of the lens sheet to be incident on and a viewing surface on the opposite side.

### ADVANTAGEOUS EFFECTS OF THE INVENTION

According to the present invention described above, it is possible to reduce the glare phenomenon of the liquid crystal display device without a significant drop in luminance of the surface light source device or the liquid crystal display device. According to the present invention, it is also possible to reduce damage to the light diffusion layer because of vibrations in such occasions as carrying the liquid crystal display device, thereby preventing defects of images displayed on the liquid crystal display device.

### BRIEF DESCRIPTION OF THE DRAWINGS

FIG. 1 is a schematic perspective view showing a prism sheet which is an exemplary embodiment of the lens sheet according to the present invention, an exemplary embodiment of the surface light source device according to the present invention which uses the prism sheet, and an exemplary embodiment of the liquid crystal display device which uses the surface light source device;

FIG. 2 is a schematic partial cross-sectional view of FIG. 1;

FIG. 3 is an enlarged schematic partial cross-sectional view of the prism sheet and a light guide;

FIG. 4 is a schematic plan view showing a secondary particle;

FIG. 5 is a schematic diagram for explaining the method of manufacturing a prism sheet;

FIG. 6 is a schematic perspective view showing a roll die which is used for manufacturing a prism sheet; and

FIG. 7 is a schematic exploded perspective view showing a roll die which is used for manufacturing a prism sheet.

### LIST OF REFERENCE SIGNS IN THE DRAWINGS

1: primary light source
2: light source reflector
3: light guide
31: light incident end surface
32: end surface
33: light emission surface
34: back surface
4: prism sheet
41: light incident surface
411: elongated prism
411a, 411b: prism face
42: light exit surface
43: transparent base
44: elongated prism formed layer
45: light diffusion layer
451: transparent resin
452: light diffusing agent
453: secondary particle
454: light diffusing agent
5: light reflecting element
7: die member (roll die)
8: liquid crystal panel
81: light incident surface
82: viewing surface
9: transparent base
10: active energy ray curing composition
11: pressure mechanism
12: resin tank
13: nozzle
14: active energy ray irradiation device
15: sheet-like die member
16: cylindrical roll
18: shape transfer surface
28: nip roller

### BEST MODE FOR CARRYING OUT THE INVENTION

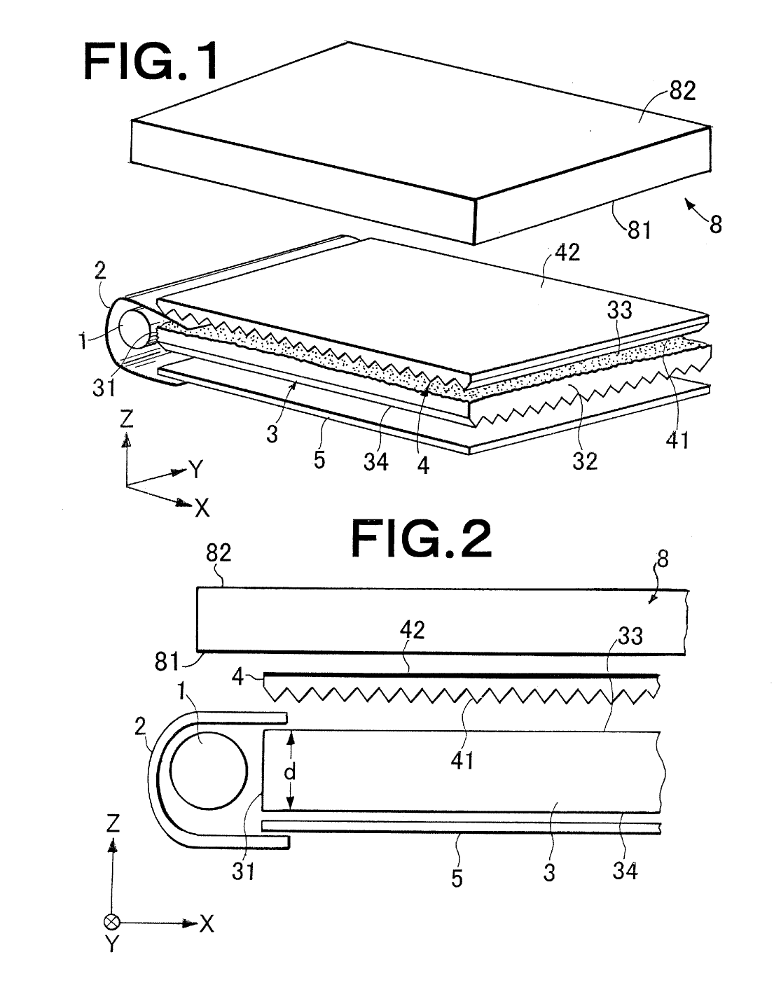

Hereinafter, exemplary embodiments of the present invention will be described with reference to the drawings. FIG. 1 is a schematic perspective view showing a prism sheet which is an exemplary embodiment of the lens sheet according to the present invention, an exemplary embodiment of the surface light source device according to the present invention which uses the prism sheet, and an exemplary embodiment of the liquid crystal display device according to the present invention which uses the surface light source device. FIG. 2 is a schematic partial cross-sectional view of the same. In the exemplary embodiment, the surface light source device includes: a light guide 3 which has at least one of its end surface as a light incident end surface 31 and one surface generally orthogonal thereto as a light emission surface 33; a primary light source 1 of linear shape which faces the light incident end surface 31 of the light guide 3 and is covered with a light source reflector 2; a prism sheet 4 as a light deflecting element which is arranged over the light emission surface of the light guide 3; and a light reflecting element 5 which faces a back surface 34 of the light guide 3 opposite from the light emission surface 33. In the exemplary embodiment, the liquid crystal display device includes the surface light source device and a liquid crystal panel (liquid crystal display element) 8 which is arranged over a light exit surface 42 of the prism sheet 4.

The light guide 3 is arranged in parallel with an XY plane and has a rectangular plate shape as a whole. The light guide 3 has four end surfaces, including a pair of end surfaces parallel to a YZ plane. At least one of the pair is the light incident end surface 31. The light incident end surface 31 faces the primary light source 1. Light emitted from the primary light source 1 is incident on the light incident end surface 31 and let into the light guide 3. In the present invention, another light source may be provided so as to face another end surface, such as the end surface 32 opposite from the light incident end surface 31.

The two principal surfaces of the light guide 3 generally orthogonal to the light incident end surface 31 are both positioned generally in parallel with the XY plane. Either one of the surfaces (the top surface in the diagrams) serves as the light emission surface 33. The light emission surface 33 is provided with a directional light emitting mechanism consisting of a roughened surface or a plurality of elongated lenses so that while the light incident on the light incident end surface 31 is guided through the light guide 3, light having directionality within a plane orthogonal to the light incident end surface 31 and the light emission surface 33 (XZ plane) is emitted from the light emission surface 33. Within the XZ plane distribution, the angle formed between the direction of the peak in the luminous intensity distribution of the emitted light (peak light) and the light emission surface 33 shall be denoted by α. The angle α ranges from 10° to 40°, for example. The luminous intensity distribution of the emitted light has a full width at half maximum of 10° to 40°, for example.

In terms of achieving uniform luminance within the light emission surface 33, the roughened surface or elongated lenses formed on the surface of the light guide 3 preferably has an ISO 4287/1-1984 average angle of inclination or average inclination angle θa in the range of 0.5° to 15°. The more preferable range of the average angle of inclination θa is 1° to 12°, and even more preferably 1.5° to 11°. The optimum range of the average angle of inclination θa is preferably determined according to the ratio between the thickness (d) of the light guide 3 and the length (L) of propagation of the incident light, i.e., L/d. Specifically, if the light guide 3 has an L/d of around 20 to 200, the average angle of inclination θa preferably falls within the range of 0.5° to 7.5°, more preferably within the range of 1° to 5°, and even more preferably within the range of 1.5° to 4°. If the light guide 3 has an L/d of around 20 or less, the average angle of inclination θa preferably falls within the range of 7° to 12°, and more preferably within the range of 8° to 11°.

To determine the average angle of inclination θa of the roughened surface formed on the light guide 3, the configuration of the roughened surface is measured by a stylus type surface roughness meter according to ISO 4287/1-1984. From the resulting inclination function f(x) where x is the coordinate in the measuring direction, the average angle of inclination θa can be determined by using the following equations (1) and (2):

Δa=(1/L)∫₀^{L}|(d/dx)f(x)|dx, and (1)

θa=tan⁻¹(Δa) (2)

where L is the measured length, and Δa is the tangent of the average angle of inclination θa.

The light guide 3 preferably has a light emission rate in the range of 0.5% to 5%, and more preferably in the range of 1% to 3%. Light emission rates of 0.5% and above can increase the amount of light emitted from the light guide 3 for sufficient luminance. Light emission rates of 5% and below can prevent a large amount of light being emitted near the primary light source 1, which reduces the attenuation of the emission light in the light emission surface 33 in the X direction and improves the uniformity of luminance of the light emission surface 33. When the light emission rate of the light guide 3 is set at 0.5% to 5%, the light guide 3 can emit light with a highly-directional emission characteristic such that the angle of the peak light in the luminous intensity distribution (in the XZ plane) of the light emitted from the light emission surface falls within the range of 50° to 80° with respect to the normal to the light emission surface, and the full width at half maximum of the luminous intensity distribution (in the XZ plane) of the emission light is 10° to 40° in the XZ plane orthogonal to both the light incident end surface and the light emission surface. The direction of emission can thus be deflected by the prism sheet 4 efficiently, and it is possible to provide a surface light source device having high luminance.

In the present invention, the rate of light emission from the light guide 3 will be defined as follows. Assuming that d is the thickness of the light guide 3 (dimension in the Z direction), the intensity (I₀) of the light emitted from the light emission surface 33 at the edge on the side of the light incident end surface 31 and the intensity (I) of the light emitted from the light emission surface 33 at a position of distance L from the edge on the side of the light incident end surface 31 satisfy the relationship given by the following equation (3):

I=I₀(α/100)[1−(α/100)]^{L/d} (3)

where the constant α is the light emission rate, or the rate (in percentage: %) of light emitted from the light emission surface 33 per unit length (a length equivalent to the light guide thickness d) of the light guide 3 in the X direction orthogonal to the light incident end surface 31. The light emission rate a can be determined from the gradient of the relationship when plotted with the logarithm of the intensity of the light emitted from the light emission surface 23 as the ordinate and (L/d) as the abscissa.

In the present invention, light diffusing fine particles may be mixed and dispersed into the light guide to implement a directional light emitting mechanism instead of or in combination with the light emitting mechanism that is formed on the light emission surface 33 as described above.

The back surface 34, a principal surface not provided with the directional light emitting mechanism, is formed as an elongated prism formed surface. A large number of elongated prisms or prism rows extending in a direction that crosses the light incident end surface 31, or more specifically in the direction (X direction) generally perpendicular to the light incident end surface 31, are arranged on the elongated prism formed surface in order to control the directionality of the emission light from the light guide 3 in the plane parallel to the primary light source 1 (YZ plane). The elongated prisms on the back surface 34 of the light guide 3 may have an array pitch in the range of 10 to 100 μm, for example, and preferably in the range of 30 to 60 μm. The elongated prisms on the back surface 34 of the light guide 3 may have a vertex angle in the range of 85° to 110°, for example. The reason is that vertex angles in this range can collect the emission light from the light guide 3 appropriately to improve the luminance of the surface light source device. The more preferable range of vertex angles is 90° to 100°.

The light guide 3 is not limited to the shape shown in FIG. 1, but may have various shapes such as a wedge-like shape with the side of the light incident end surface greater in thickness.

The light guide 3 may be made of a synthetic resin with high light transmittance. Examples of such a synthetic resin include methacrylic resins, acrylic resins, polycarbonate resins, polyester resins, and vinyl chloride resins. In particular, methacrylic resins have high light transmittance and excellent heat resistance, dynamic characteristics, and moldability, and are best suited. Among such methacrylic resins, ones consisting mainly of methacrylate methyl, with 80% or more methacrylate methyl by weight, are preferred. Surface structures such as a roughened surface, elongated prism, and lenticular lens array can be formed on the light guide 3 by hot pressing a plate of transparent or translucent synthetic resin with a die member having a desired surface structure. Shaping may be performed simultaneously with molding such as extrusion molding and injection molding. Thermosetting or light-curing resins may be used to form a structured surface. A rough surface structure or an elongated lens array structure made of an active energy ray curing resin may be formed on the surface of a transparent film, sheet, or other transparent base that is made of a polyester resin, acrylic resin, polycarbonate resin, vinyl chloride resin, polymethacrylimide resin, etc. Such a sheet may be joined and integrated onto another transparent base by adhesion, fusion, or other techniques. Active energy ray curing resins available include multifunctional (meth)acrylic compounds, vinyl compounds, (meth)acrylic esters, allyl compounds, and (meth)acrylic metal salts.

The prism sheet 4 is arranged over the light emission surface 33 of the light guide 3. The prism sheet 4 is made of a sheet-like transparent member. Its two principal surfaces, or a first surface 41 and a second surface 42, are arranged in parallel with each other as a whole, and are arranged in parallel with the XY plane as a whole. The first surface 41, one of the principal surfaces (the principal surface facing the light emission surface 33 of the light guide 3), serves as a light incident surface. The other principle surface 42 serves as a light exit surface. The light incident surface 41 is formed as an elongated prism formed surface on which a plurality of elongated prisms extending in the Y direction are arranged in parallel with each other. The light exit surface 42 is configured as an irregular surface.

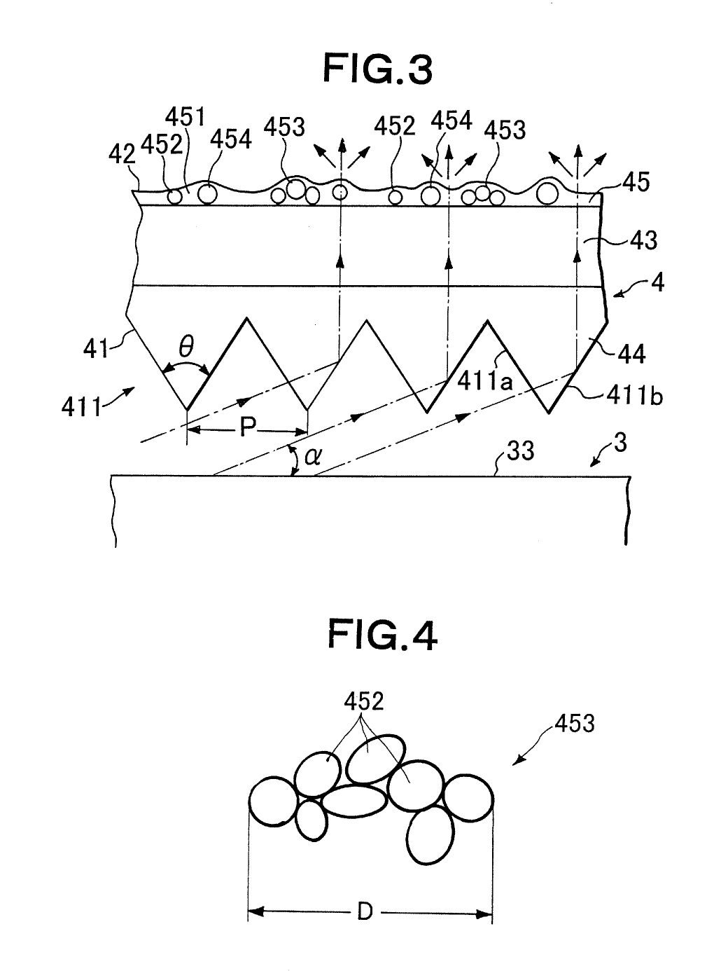

FIG. 3 shows an enlarged schematic partial cross-sectional view of the prism sheet 4 and the light guide 3. The prism sheet 4 is composed of a transparent base 43, a transparent elongated lens formed layer or transparent elongated prism formed layer 44, and a light diffusion layer 45. The transparent base 43, elongated prism formed layer 44, and light diffusion layer 45 constitute the sheet-like transparent member. Elongated prisms 411 are formed on the underside of the elongated prism formed layer 44. This underside makes the light incident surface 41. The top side of the light diffusion layer 45 makes the light exit surface 42.

The transparent base 43 is preferably made of material that transmits active energy rays such as ultraviolet rays and electron beams. Aside from a flexible glass plate and the like, preferred examples of such material include transparent resin sheets and films of: polyester resins such as polyethylene terephthalate and polyethylene naphthalate; acrylic resins such as polymethyl methacrylate; cellulose resins such as diacetyl cellulose and triacetyl cellulose; styrene resins such as polystyrene and acrylonitrile-styrene copolymer; olefin resins such as polyethylene, polypropylene, polyolefin having a cyclic or norbornene structure, and ethylene-propylene copolymer; polyamide resins such as nylon and aromatic polyamide; polycarbonate resins; vinyl chloride resins; and polymethacrylimide resins.

In terms of working properties such as strength and operability, the transparent base 43 preferably has a thickness of, e.g., 10 to 500 μm, and more preferably 20 to 400 μm, and particularly preferably 30 to 300 μm. Adhesion enhancing treatments such as anchor coating are preferably applied to the surface of the transparent base 43 so that the elongated prism formed layer 44 made of an active energy ray curing resin and the transparent base 43 have an enhanced adhesion therebetween.

The elongated prism formed layer 44 has a smooth top surface, which is joined to the underside of the transparent base 43. The underside of the elongated prism formed layer 44, i.e., the light incident surface 41 is an elongated prism formed surface, on which the plurality of elongated prisms 411 extending in the Y direction are arranged in parallel with each other. The elongated prism formed layer 44 has a thickness of 10 to 500 for example. The elongated prisms 411 have an array pitch P of 10 μm to 500 μm, for example.

Each elongated prism 411 has two prism faces 411a and 411b. The prism faces may be made optically sufficiently smooth (mirror finished) or may be rough. In the present invention, the prism faces are preferably mirror finished in terms of maintaining desired optical characteristics of the prism sheet. The elongated prisms 411 preferably have a vertex angle θ in the range of 40° to 150°. In LCD backlights, the elongated prisms are typically given a vertex angle θ in the range of around 80° to 100°, and preferably in the range of 85° to 95°, if the prism sheet is arranged with its elongated prism formed surface toward the liquid crystal panel. If the prism sheet 4 is arranged with its elongated prism formed surface toward the light guide 3 as in the exemplary embodiment, on the other hand, the elongated prisms 411 are given a vertex angle θ in the range of around 40° to 75°, and preferably in the range of 45° to 70°.

The elongated prism formed layer 44 is made of an active energy ray curing resin, for example, and has a refractive index of 1.52 to 1.6 or so. The active energy ray curing resin for forming the elongated prism formed layer 44 is not particularly limited as long as it cures with active energy rays such as ultraviolet rays and electron beams. Examples include polyesters, epoxy resins, and (meth)acrylate resins such as polyester (meth)acrylate, epoxy (meth)acrylate, and urethane (meth)acrylate. Of these, (meth)acrylate resins are particularly preferable in view of optical properties etc. Active energy ray curing compositions that are suitable for such curing resins in terms of operability, curing property, and the like include: multifunctional acrylates and/or multifunctional methacrylates (hereinafter, referred to as multifunctional (meth)acrylates); monoacrylates and/or monomethacrylates (hereinafter, referred to as mono(meth)acrylates); and compositions consisting mainly of photoinitiators for active energy rays. Typical multifunctional (meth)acrylates include polyol poly(meth)acrylate, polyester poly(meth)acrylate, epoxy poly(meth)acrylate, and urethane poly(meth)acrylate. These compositions are used alone or as a mixture of two or more. Mono(meth)acrylates include mono (meth) acrylic ester of monoalcohol and mono (meth) acrylic ester of polyol.

Now, the light diffusion layer 45 is made of a transparent resin 451 that contains a large number of particles of a first light diffusing agent 452 and/or second light diffusing agent 454 and/or third light diffusing agent (though not shown, denoted by the reference numeral 455 for convenience). The light diffusing agents protrude from the surface of the layer of transparent resin 451, whereby the surface of the light diffusion layer 45 is formed as an irregular surface.

The method of forming the light diffusion layer 45 is not particularly limited, and any appropriate method may be used. For example, the transparent resin 451 is dissolved into a solvent, to which necessary amounts of light diffusion agents 452 and 454 are added to prepare a dope (coating material). The dope is applied to coat the surface of the transparent base 43, and dried to form irregular structures of the light diffusing agents 452 and 454 on the surface. The configuration of the irregularities can be easily adjusted by the content of the transparent resin in the dope, the amount of coating, and the particle sizes of the light diffusing agents 452 and 454. The height of the irregularities can be appropriately adjusted to develop necessary haze. The configuration of the irregular structures depends on the shapes of the light diffusing agents 452 and 454. For example, with spherical light diffusing agents, the resulting configuration is like a group of small concave and convex lenses. If the irregularities are too large in height, the surface of the light diffusion layer 45 easily forms local angles exceeding the critical angle of the incident light from the transparent base 43 with respect to the surface of the transparent base. In such cases, part of the emission surface of the light diffusion layer 45 turns the light into loss light by total reflection, with a drop in the luminance of the surface light source device. It is therefore preferable that the irregularities of the light diffusion layer 45 have a height not to produce so steep inclinations as to cause the total reflection mentioned above.

The light diffusion layer 45 may further contain a third light diffusing agent 455 if necessary. Here, protruding structures formed by the third light diffusing agent preferably protrude in the range of 3 to 25 μm from the reference surface of the light diffusion layer. The range is more preferably 4 to 15 μm, and particularly preferably 4 to 10 μm. The reference surface of the light diffusion layer shall refer to the surface on the assumption that the irregular structures of the light diffusion layer are averaged and smoothed out. In other words, the reference surface is a smooth surface having an average coating thickness. The average coating thickness can be calculated by dividing the average amount of application per unit area by the specific gravity of the light diffusion layer components. The protruding structures can reduce the contact area between the liquid crystal panel and the light diffusion layer, thereby preventing flaws of visible sizes from occurring due to friction between the liquid crystal panel and the light diffusion layer. Such structure of the light diffusion layer can be suitably used even for applications where high wear resistance against vibrations is required, such as a backlight that is intended for a surface light source device for carrying purposes in particular. Here, since the third light diffusing agent 455 can produce steep surface inclinations that cause the total reflection, it is necessary to adjust the amount of addition of the third light diffusing agent 455 so as not to lower the luminance of the surface light source device.

The dope may be prepared by using typical solvents such as toluene, methyl ethyl ketone, methyl isobutyl ketone, ethyl acetate, butyl acetate, isopropyl alcohol, and ethanol. Available methods for coating the dope include gravure coating, lip coating, and coating methods using a Comma coater, roll coater, etc.

For the transparent resin 451, any resin may be used with no particular limitation as long as the resin allows the dispersion of the light diffusing agents 452, 454, and/or 455 and has sufficient strength and transparency. Examples of such a transparent resin include: thermoplastic resins such as polyamide resins, polyurethane resins, polyester resins, and acrylic resins; thermosetting resins; and active energy ray curing resins (ionized radiation curing resin). Of these, an appropriate resin is preferably selected in consideration of such factors as adhesion to the transparent base 43 and the light diffusion agents 452 and 454. Acrylic resins having high transmittance are particularly preferable for use.

Among preferred acrylic resins are hydroxyalkyl (meth)acrylates such as 2-hydroxyethyl methacrylate and 2-hydroxyethyl acrylate, and methyl (meth)acrylates, ethyl (meth)acrylates, and acrylic acid and other polymers. In view of strength and adhesion to the transparent base, particularly preferable acrylic resins can be obtained by: dissolving acrylic polyols containing hydroxyalkyl (meth)acrylates as monomeric units into toluene, methyl ethyl ketone, or other solvent; mixing the solution with a crosslinking agent such as oligomerized isocyanate compounds of bifunctional isocyanate monomers, isocyanurates, and the like, and melamines; and applying the resultant, followed by curing. For acrylic polyol copolymer components, alkyl acrylates are preferably contained since they enhance the dispersibility of silicone resin fine particles. In view of heat resistance, the transparent resin 451 preferably has a glass transition point of 60° C. or higher.

The transparent resin 451 may contain such additives as leveling agents, thixotropic agents, slipping agents, antifoaming agents, antistatic agents, and ultraviolet absorbers. Of these, leveling agents can be contained to suppress aggregation of the light diffusing agents 452, 454, and/or 455, and to facilitate the formation of irregularities by the light diffusing agents 452, 454, and/or 455. Slipping agents can be added to prevent damage when friction occurs with the surface of the liquid crystal panel. Commercially available slipping agents including silicone-based, fluorine-based, paraffin-based, and mixture thereof may be used without particular limitation. Examples include BYK series from BYK Japan KK.

The light diffusing agents 452, 454, and 455 may be selected and used as appropriate from among inorganic fine particles such as silica, alumina, and glass, crosslinked organic fine particles such as polymethyl methacrylate, polystyrene, polyurethane, acryl-styrene copolymer, benzoguanamine, and melamine, and silicone resin fine particles, etc. The light diffusing agents 452, 454, and 455 may be used regardless of shape, including spherical, amorphous, bowl-like, spheroidal, and needle-like.

In the present invention, it is particularly preferable to use an acrylic resin and silicone resin particles for the transparent resin and a light diffusing agent, respectively, since the combination provides excellent dispersibility of the resin particles in the light diffusion layer, excellent appearance of the coating, and smooth appearance with less glare. When using the foregoing combination, the light diffusion layer preferably contains silicone resin particles in a ratio of 50% or higher by volume, with which the foregoing effect is exerted significantly. The ratio is more preferably 55% or higher by volume, and particularly preferably 60% or higher by volume.

Assuming that H1 is the surface haze of the light diffusion layer and H2 the internal haze, the ratio of the internal haze H2 to the total haze (H1+H2) is required to be 20% to 90%. The purpose is to increase not only the surface diffusion but also the internal diffusion in ratio so that light is diffused both inside and at the surface of the light diffusion layer, whereby the spatial mixing of the diffused light is enhanced for suppressed glare production. The ratio of the internal haze H2 is preferably 40% to 90%, more preferably 45% to 85%, and particularly preferably 50% to 80%. With the internal haze H2 exceeding 90% in ratio, the transmittance drops to decrease the luminance and half-value angle of the surface light source device.

In the present invention, the ratio of the amount of the light diffusing agents having particle sizes of 1 to 4 μm with respect to the total amount of the light diffusing agents (content ratio) is 50% or higher by volume. The ratio is more preferably 55% or higher by volume, and particularly preferably 60% or higher by volume. The presence of particles below 1 μm in particle size may produce coloring. Particles of 4 μm or less in particle size can be used to reduce glare significantly. The foregoing ratios of particles with particle sizes of 1 to 4 μm make it possible to suppress glare when the lens sheet having this light diffusion layer is used in a surface light source device.

To calculate the volume ratio of light diffusing agents having particle sizes of 1 to 4 μm with respect to the total amount of light diffusing agents, a particle size distribution has only to be known if a single type of light diffusing agent is contained alone. If a plurality of types of light diffusing agent particles are contained, the volume ratio can be easily calculated from the particle size distribution, specific gravities, and the ratios of presence of the respective types of light diffusing agents. The method for measuring the particle size distribution(s) is not particularly limited. For example, a coal-tar counter method, laser measurement method, and the like may be used.

If the particle size distribution and the ratios of presence are unknown, they can be calculated from a plan view image of the light diffusion layer observed under an optical microscope or the like. For example, if the light diffusing agents are spherical, 50 particles of the light diffusing agents are selected at random from a 500-μm-side square area on a plan view image of the light diffusion layer and measured for particle size. This measurement is performed on three different locations of the light diffusion layer. The particle size distribution of the resulting particle sizes with respect to the number of particles can be transformed into a volume-based distribution to calculate the foregoing ratio (volume ratio). If the light diffusing agents are not spherical in shape, the ratio can be calculated by performing the calculation of the foregoing method on the assumption that each particle of the light diffusing agents is spherical with its major axis diameter as the diameter on a plan view image.

The first light diffusing agent 452 in use preferably has an average particle size of 1 to 4 μm, more preferably 1.5 to 3.8 μm, and particularly preferably 2.0 to 3.5 μm. If the average particle size of the first light diffusing agent 452 falls below 1 μm, light beams transmitted through the light diffusion layer 45 can be colored to lower the color temperature of the surface light source device. The defect hiding capability can also drop. If the average particle size of the first transparent light diffusing agents 452 exceeds 4 μm, a glare phenomenon tends to occur strongly. A second first light diffusing agent is preferably contained to form irregularities on the surface of the light diffusion layer in order to increase the ratio of the surface haze and adjust the ratio of the internal haze to within 90%. The preferable range of particle sizes of the second first light diffusing agent is thus 4.0 to 8.5 μm, and more preferably 4.0 to 6.5 μm. In such cases, it is preferable for the sake of convenience in adjusting the internal haze that the second first light diffusing agent has particle sizes in the range of 75% to 150% with respect to the average coating thickness of the light diffusion layer.

In the present invention, a second light diffusing agent 454 may also be used as needed in order to adjust the ratio of the internal haze to the total haze and to improve the appearance of the light diffusion layer. Since the light diffusion layer 45 contains the two types of light diffusing agents having different average particle sizes, the heights of the irregularities on the surface of the light diffusion layer 45 vary from one location to another. The two light diffusing agents also lie in random positions on the surface of the light diffusion layer 45, with the effect of improving the film appearance. Even if the two light diffusing agents have the same average particle size, the same effects can also be obtained as long as the light diffusing agents are of respective different types and have respective different refractive indexes.

Like the light diffusing agents 452 and 454, the third light diffusing agent 455 may be selected and used as appropriate from among inorganic fine particles such as silica, alumina, and glass, crosslinked organic fine particles such as polymethyl methacrylate, polystyrene, polyurethane, acryl-styrene copolymer, benzoguanamine, and melamine, and silicone resin fine particles, etc. The light diffusing agent 455 preferably has a spherical shape so as to reduce friction with the surface of the liquid crystal panel.

For the sake of compatibility with various types of liquid crystal panel surfaces, the light diffusing agent 455 is required to have appropriate hardness. The reason is that if the light diffusing agent 455 has only insufficient hardness, the particles of the light diffusing agent can be ground away and no longer provide the function of reducing the contact area when the surface of the liquid crystal panel has a fine asperity structure for antiglare purpose. If the light diffusing agent 455 has excessive hardness, on the other hand, it can damage the surface of the liquid crystal panel.

An example of the light diffusing agent 455 having appropriate hardness is polymethyl methacrylate crosslinking particles containing a crosslinking agent by 20% to 50%. Among commercially available products are Techpolymer products XX-series from Sekisui Plastics Co., Ltd. Of these, XX-38B, XX-39B, and XX-71B containing a crosslinking agent by 30% are particularly suitable.

For the light diffusing agent 455, ones having rubber elasticity can also be suitably used for the sake of wear resistance. Such agents are effective in preventing damage to the surface of the liquid crystal panel when the liquid crystal panel has a smooth surface in particular. Examples include hybrid silicone powder KMP-600 series from Shin-Etsu Chemical Co., Ltd., and Techpolymer BMX series and ARX series from Sekisui Plastics Co., Ltd.

The third light diffusing agent 455 preferably has a particle size of 7 to 30 μm, more preferably 8 to 20 μm, and even more preferably 9 to 13 μm. Particle sizes below 5 μm fail to form a protruding structure of sufficient height, with no improvement in wear resistance. Particle sizes above 30 μm make the liquid crystal display extremely worse in glare and evenness.

The third light diffusing agent 455 preferably has a narrow distribution of particle sizes. That is, if the particle sizes are distributed widely, stress can concentrate on the extremities of a small number of large particles of the third light diffusing agent 455 to increase damage to the particles and damage to the surface of the liquid crystal panel when the light diffusion layer comes into contact with the surface of the liquid crystal panel. For this reason, the third light diffusing agent 455 preferably has a weight-based particle size distribution with a standard deviation of 5 μm or less, more preferably 3 μm or less, and even more preferably 2 μm or less.

The third light diffusing agent 455 is preferably added in an amount of 0.001 to 1 g/m², more preferably 0.005 to 0.5 g/m², and particularly preferably 0.01 to 0.25 g/m² per unit area of the light diffusion layer. Below 0.001 g/m², stress can concentrate to damage the surface of the liquid crystal panel due to too few protruding structures. Above 1 g/m², on the other hand, steep surface inclinations that can cause total reflection increase to lower the luminance.

If the third light diffusing agent 455 is contained, the difference between the average particle size of the second light diffusing agent 454 and the average partial size of the third light diffusing agent 455 is preferably 1 μm or greater, more preferably 3 μm or greater, and particularly preferably 5 μm or greater. When the surface of the liquid crystal panel has a fine asperity structures, light diffusing agents having such particle sizes can be used in combination to reduce the contact between the extremities of the asperities and the surface of the light diffusion layer for improved wear resistance.

To produce internal scattering on the basis of refractive index discontinuity at the interface between the light diffusing agent 452 and the transparent resin 451, thereby suppressing a speckle, and to suppress unnecessary scattering at the interface, thereby suppressing a drop in luminance, the difference Δn1 between the refractive index N2 of the first light diffusing agent 452 and the refractive index N1 of the transparent resin 451 is preferably 0.03 to 0.10, more preferably 0.04 to 0.09, and particularly preferably 0.05 to 0.08.

The second light diffusing agent preferably has a particle size in the range of 1.0 to 6.0 μm, more preferably 2.5 to 5.0 μm, and particularly preferably 2.5 to 4.0 μm. The second light diffusing agent having the foregoing refractive indexes and particle sizes can be added to facilitate adjusting the ratio of the internal haze to the total haze to the preferred range of the present invention.

The difference Δn3 between the refractive index N4 of the third light diffusing agent 455 and the refractive index of the transparent resin 451 is preferably 0.00 to 0.08, and more preferably 0.00 to 0.07, so that surface scattering occurs mainly from the irregularities at the interface between the light diffusion layer 45 and the air.

When using a plurality of types of light diffusing agents, the content of the first light diffusing agent 452 in the light diffusion layer 45 is preferably 50% or higher by volume, more preferably 55% or higher by volume, and particularly preferably 60% or higher by volume with respect to the total amount of the light diffusing agents added. This content range is important in setting the ratio of the internal haze to the total haze at 20% or higher to resolve glare phenomenon.

When using the second light diffusing agent in combination with the first light diffusing agent, the contents of the first light diffusing agent 452 and the second light diffusing agent 454 with respect to the amount of the transparent resin 451 are preferably as follows. To set the total haze of the light diffusion layer 45 at 50% to 85% and to set the ratio of the internal haze H2 at 40% or higher, it is preferable that the amount of addition of the first light diffusion agent 452 is generally 10% to 20% by weight with respect to the transparent resin 451. Similarly, the amount of addition of the second light diffusing agent 454 is preferably 5% to 15% by weight with respect to the transparent resin 451. If the contents of the light diffusing agents 452 and 454 are lower than the foregoing amounts, the total haze of the light diffusion layer 45 falls below 50% and the viewing angle of the surface light source device tends to decrease. If the contents of the light diffusing agents 452 and 454 are higher than the foregoing amounts, the total haze of the light diffusion layer 45 exceeds 85% and the luminance tends to decrease.

The irregular surface of the light diffusion layer 45 is formed so that the irregularities have an average distance or average spacing between local peaks S, defined in JIS B 0601-1994, of 40 μm or less, preferably 35 μm or less, and more preferably 30 μm or less. The irregular surface of the light diffusion layer 45 is also formed so that the irregularities have a ten-point average roughness Rz, defined in JIS B 0601-1994, of 4.0 μm or less, preferably 3.5 μm or less, and more preferably 3.0 μm or less. In terms of preventing sticking to the liquid crystal panel, Rz is desirably 0.5 μm or more, and preferably 1.0 μm or more. Forming the irregular surface of the light diffusion layer 45 in the above manner is particularly important in suppressing a glare phenomenon.

Fine particles like the light diffusing agents 452 and 454 may sometimes gather in several numbers and aggregate inside the coating solution to form secondary particles 453. The aggregation depends on such factors as differences in affinity due to different SP values (solubility parameters) of the light diffusing agents 452 and 454 to the transparent resin 451 and the solvent, the surface potentials of the light diffusing agents 452 and 454, the viscosity of the dope at the time of coating, the length of the leveling time (the duration from coating to drying), and the presence or absence of leveling agents, etc. The average distance between local peaks S of the irregularities tends to increase as the aggregation in the in-plane direction of the coating film increases. The ten-point average roughness Rz tends to increase as the aggregation in the thickness direction of the coating film increases.

For glare suppression, the number of secondary particles 453 having a major axis diameter of 30 μm or greater is desirably less than or equal to three, preferably less than or equal to two, and more preferably less than or equal to one in a circular area of 70 μm in radius in any arbitrary position of the light diffusion layer 45. Secondary particles having a major axis diameter of no greater than 20 μm, within the foregoing range of numbers, are more preferable. As shown in a plan view of FIG. 4, a secondary particle 453 typically has a planar shape of non-circular configuration, being made of an aggregate of a plurality of particles of light diffusing agents 452 and 454 (shown as 452 in the diagram). The size of the secondary particle 453 is thus represented by the major axis diameter D.

Assuming such an aggregated secondary particle as a primary particle, the presence of a secondary particle translates into the addition of an extremely large particle. To suppress aggregation is thus extremely important from the foregoing reasons.

In the exemplary embodiment described above, the light diffusion layer 45 is formed by the application of a dope that contains the transparent resin 451, the light diffusing agents 452, and if necessary, 454 and/or 455. The haze of the light diffusion layer 45 can thus be adjusted easily by the amounts of addition of the light diffusing agents 452, 454, and 455, whereby the luminance, viewing angle, and other performances of the surface light source device can suitably be adjusted easily.

In the present invention, however, the light diffusion layer having an irregular surface may be formed by other methods. For example, the surface of a transparent base may be roughened in advance by using chemical etching, sand blasting, emboss rolling, or the like to form the irregular surface. A transparent base may be coated with an additional coating film of transparent resin, and irregular structures may be added to the surface of the resulting transparent resin film by using a die transfer method or the like. Two or more of the foregoing methods may be combined to form a composite irregular surface having different irregular structures. Light diffusing agents such as described above may be added to the resins that form these irregular surfaces, so as to control the ratio of the internal haze H2 to the total haze appropriately.

The foregoing description has dealt with the case where the prism sheet 4 has an elongated prism formed layer 44 separate from the transparent base 43, whereas in the present invention the transparent base 43 and the elongated prism formed layer 44 may be made of a common member. That is, the elongated prisms may be formed on the surface of the transparent base 43. In this case, the transparent base 43 may be made of a synthetic resin having high light transmittance. Examples of such a synthetic resin include methacrylic resins, acrylic resins, polycarbonate resins, polyester resins, and vinyl chloride resins. In particular, methacrylic resins have high light transmittances and excellent heat resistance, dynamic characteristics, and moldability, and are best suited. Among such methacrylic resins, ones consisting mainly of methyl methacrylate, with 80% by weight or more of methyl methacrylate, are preferred.

FIG. 3 schematically shows how light is deflected by the prism sheet 4 in the XZ plane. The diagram shows an example of the traveling directions of peak light (light corresponding to the peak in the distribution of emission light) emitted from the light guide 3 in the XZ plane. Most of the peak lights emitted obliquely from the light emission surface 33 of the light guide 3 at an angle of α is incident on the first prism faces 411a of the elongated prisms 411. The light is totally reflected by the second prism faces 411b to travel generally in the normal direction of the light exit surface 42, and is diffused mainly by the surfaces of the irregular structures of the light diffusion layer 45 for emission. In the YZ plane, the foregoing action of the elongated prisms on the back surface 34 of the light guide is also added to provide a sufficient improvement in luminance in the normal direction of the light exit surface 42 across a wide range of area.

The prism faces 411a and 411b of the elongated prisms 411 on the prism sheet 4 are not limited to a single plane in shape. For example, a convex polygonal cross-sectional shape or convex curved shape can be employed for a further improvement in luminance and for a narrower field of view.

In order to form elongated prisms of desired shapes precisely for stable optical characteristics and to prevent wear and deformation of the vertexes of the elongated prisms during assembly operations and during use of the light source device, the prism sheet 4 may be formed with flat top portions or curved top portions at the vertexes of the elongated prisms. The flat top portions or curved top portions preferably have a width of 3 μm or less from the viewpoint of preventing both a drop in the luminance of the surface light source device and production of an uneven luminance pattern due to a sticking phenomenon. The flat top portions or curved top portions more preferably have a width of 2 μm or less, and even more preferably 1 μm or less.

The elongated prisms described above can be formed by shaping the surface of a synthetic resin sheet with a die member that has a shape transfer surface for transferring the configuration of the light incident surface 41 which is the elongated prism formed surface having the elongated prisms 411.

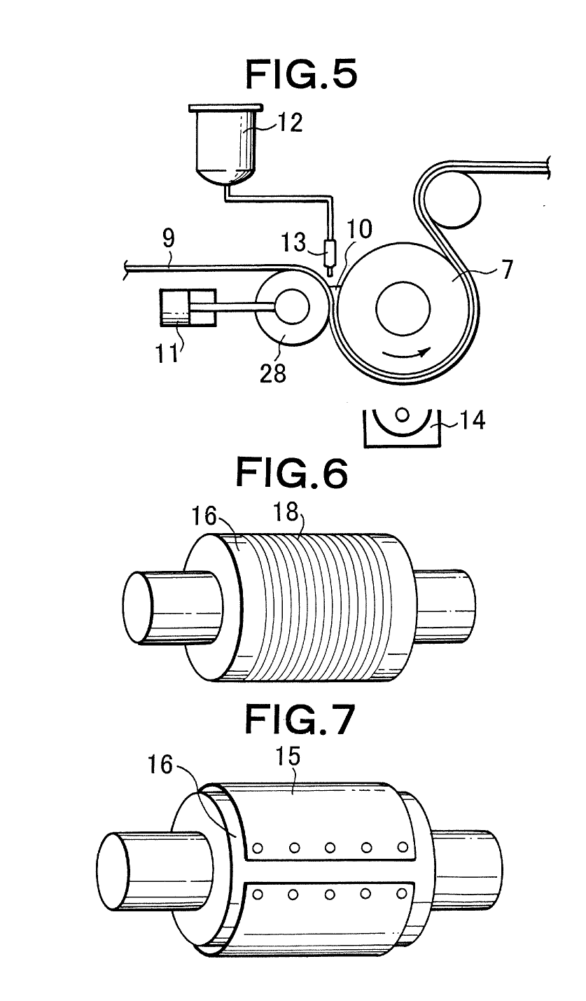

FIG. 5 is a schematic diagram showing an exemplary embodiment of the formation of elongated prisms on a prism sheet.

In FIG. 5, the reference numeral 7 denotes a die member (roll die) having a cylindrical peripheral surface on which the shape transfer surface for transferring the configuration of the light incident surface 41 is formed. The roll die 7 may be made of metal such as aluminum, brass, and steel. FIG. 6 is a schematic perspective view of the roll die 7. A shape transfer surface 18 is formed on the outer periphery of a cylindrical roll 16. FIG. 7 is a schematic exploded perspective view showing a modification of the roll die 7. In this modification, a die member 15 of sheet-like shape is wound and fixed around the outer periphery of the cylindrical roll 16. The shape transfer surface is formed on the outer side of the sheet-like die member 15.

As shown in FIG. 5, a transparent base 9 (43) is fed to the roll die 7 along the outer periphery, i.e., the shape transfer surface. An active energy ray curing composition 10 is continuously supplied to between the roll die 7 and the transparent base 9 from a resin tank 12 through a nozzle 13. A nip roller 28 for making the supplied active energy ray curing compound 10 uniform in thickness is arranged outside the transparent base 9. The nip roller 28 may be a metal roller, rubber roller, etc. To uniformize the active energy ray curing composition 10 in thickness, the nip roll 28 is preferably machined with high precisions including roundness and surface roughness. With a rubber roller, the rubber hardness is preferably as high as or higher than 60°. The nip roller 28 is required to adjust the thickness of the active energy ray curing composition 10 accurately, and is operated by a pressure mechanism 11. The pressure mechanism 11 may be a hydraulic cylinder, air pressure cylinder, various types of screw mechanisms, or like. An air pressure cylinder is preferred in view of mechanism simplicity, etc. The air pressure is controlled by a pressure regulating valve or the like.

The active energy ray curing composition 10 to be supplied to between the roll die 7 and the transparent base 9 is preferably maintained at a constant viscosity in order to make the resulting prism part constant in thickness. The preferable range of viscosity is typically 20 to 3000 mPa·S, and more preferably 100 to 1000 mPa·S. Giving the active energy ray curing composition 10 a viscosity of 20 mPa·S or higher eliminates the need to set the nip pressure extremely low or to make the molding speed extremely high for the sake of making the prism part uniform in thickness. Extremely low nip pressures tend to preclude stable activation of the pressure mechanism 11, failing to uniformize the prism part in thickness. Extremely high molding speeds tend to make the amount of irradiation of the active energy rays insufficient, resulting in insufficient curing of the active energy ray curing composition. Now, if the active energy ray curing composition 10 is given a viscosity of 3000 mPa·S or less, the curing composition 10 can be spread out sufficiently even into detailed structures of the shape transfer surface of the roll die. This makes it unlikely that the precise transfer of the lens configuration becomes difficult, that defects occur easily due to trapped air, and that the productivity falls because of an extreme drop in molding speed. In order to maintain the active energy ray curing composition 10 at a constant viscosity, it is therefore preferable to provide a heat source device such as a sheath heater and a hot-water jacket outside or inside the resin tank 12 so that the curing composition 10 can be controlled in temperature.

After the active energy ray curing composition 10 is supplied to between the roll die 7 and the transparent base 9, the active energy ray curing composition 10 is irradiated with active energy rays from an active energy ray irradiation device 14 through the transparent base 9 with the active energy ray curing composition 10 sandwiched between the roll die 7 and the transparent base 9. This polymerizes and cures the active energy ray curing composition 10, transferring the shape transfer surface formed on the roll die 7. The active energy ray irradiation device 14 may be a chemical lamp intended for chemical reaction, a low-pressure mercury lamp, a high-pressure mercury lamp, a metal halide lamp, a visible-light halogen lamp, etc. The amount of irradiation of the active energy rays is preferably such that the integrated energy for wavelengths of 200 to 600 nm is 0.1 to 50 J/cm² or so. The active energy rays may be irradiated in the air or in an inactive or inert gas atmosphere such as nitrogen and argon. The prism sheet, composed of the transparent base 9 (43) and the elongated prism formed layer 44 made of the active energy ray curing resin, is then released from the roll die 7.

Returning to FIG. 1, the primary light source 1 is a light source of linear shape which extends in the Y direction. A fluorescent lamp, cold cathode tube, and the like may be used as the primary light source 1. While the primary light source 1 is arranged so as to face one of the end surfaces of the light guide 3 as shown in FIG. 1, it may also be arranged on the opposite side end surface if necessary.

The light source reflector 2 is intended to guide the light of the primary light source 1 to the light guide 3 without much loss. The light source reflector 2 may be made of such material as a plastic film having an evaporated metal reflector layer at the surface, for example. As shown in the diagram, the light source reflector 2 is wound about the outside of the primary light source 1 from the outer surface of the edge of the light reflecting element 5 to the edge of the light emission surface of the light guide 3, avoiding the prism sheet 4. Otherwise, the light source reflector 2 may be wound about the outside of the primary light source 1 from the outer surface of the edge of the light reflecting element 5 to the edge of the light exit surface of the prism sheet 4. Reflecting members similar to such a light source reflector 2 may be attached to the side end surfaces of the light guide 3 other than the light incident end surface 31.

The light reflecting element 5 may be a plastic sheet having an evaporated metal reflector layer at the surface, for example. In the present invention, the light reflecting element 5 may be made of a light reflecting layer that is formed on the back surface 34 of the light guide 3 by metal evaporation or the like, instead of the reflecting sheet.

The liquid crystal panel (liquid crystal display element) 8 of transmission type is arranged over the light-emitting surface of the surface light source device (the light exit surface 42 of the prism sheet 4) which includes the primary light source 1, the light source reflector 2, the light guide 3, the prism sheet 4, and the light reflecting element 5 described above, whereby a liquid crystal display device having the surface light source device of the present invention as a backlight is constituted. The liquid crystal display device is viewed by viewers from above.

The light emitted from the light exit surface 42 of the prism sheet 4 of the surface light source device is incident on a light incident surface 81 of the liquid crystal panel 8. The light is modulated according to an image information signal, and emitted from a viewing surface 82.

According to this exemplary embodiment, the prism sheet 4, or the light diffusion layer 45 in particular, has the characteristics described above. This makes it possible to reduce the glare phenomenon of the liquid crystal display device without a significant drop in the luminance of the surface light source device or the liquid crystal display device.

In the exemplary embodiment, the light diffusion layer 45 of the prism sheet provides a sufficient function of light diffusion particularly when the light diffusion layer 45 has a total haze of 50% or higher. This eliminates the need for the provision of an additional light diffusion sheet thereon. In the present invention, if the total haze is lower than or equal to 50%, an additional light diffusion sheet can be used in combination to reduce the glare phenomenon of the liquid crystal display device and to improve the light diffusing capability further for improved luminance.

While the foregoing exemplary embodiment has dealt with the case where a prism sheet having elongated prisms is used as the lens sheet having elongated lenses, ones having other elongated lenses such as a lenticular lens having lenticular lens arrays may be used in the present invention.

### EXAMPLES

Hereinafter, the present invention will be described in more detail in conjunction with examples thereof. Light diffusing agents to be used in the examples and the volume ratios of particles with particle sizes of 1 to 4 μm in the respective light diffusing agents are as follows:

Tospearl 130 (silicone resin fine particles)

the ratio of 1- to 4-μm particles: 88.4% by volume, and

Tospearl 145 (silicone resin fine particles)

the ratio of 1- to 4-μm particles: 25.4% by volume, where the particle size distributions were measured by a particle size distribution analyzer CAPA-700 from Horiba, Ltd.

Techpolymer product XX-49B (acrylic resin fine particles)

the ratio of 1- to 4-μm particles: 1.3% by volume, Techpolymer product XX-57B (acrylic resin fine particles)

the ratio of 1- to 4-μm particles: 96.9% by volume, and

Techpolymer product XX-38B (acrylic resin fine particles)

the ratio of 1- to 4-μm particles: 0.6% by volume, where the particle size distributions were measured by COULTER MULTISIZER from Beckman Coulter, Inc.

Chemisnow MX-500 (acrylic resin fine particles)

the ratio of 1- to 4-μm particles: 32.6% by volume, where the particle size distribution was measured by a laser diffraction type particle size distribution analyzer HELOS-KFS-Magic from Sympatec GmbH.

Compounds used in the examples will be abbreviated as follows:
methyl ethyl ketone: MEK,
methyl methacrylate: MMA,
ethyl acrylate: EA,
2-hydroxyethyl methacrylate: HEMA,
acrylic acid: MAA, and
azobisisobutyronitrile: AIBN.

### Manufacturing Example 1

In a 2 L separable flask of a polymerization reaction vessel, 106 weight parts of toluene, 71 weight parts of MEK, 69 weight parts of MMA, 25 weight parts of EA, 5 weight parts of HEMA, and 1 weight part of MAA were measured. Nitrogen bubbling was performed for 30 minutes along with agitation by a mixing impeller. After 0.45 weight parts of AIBN was added as a radical polymerization initiator, the reaction vessel was heated to 90° C. and stored in that state for five hours. One weight part of AIBN was further added thereto and the reaction was maintained for four hours. The resultant was cooled to room temperatures to finish the reaction, thereby obtaining a solution of acrylic resin A.

The acrylic resin A had a molecular weight MW=75100, with a hydroxyl number of 21.6 mgKOH/g, an acid number of 2.1 mgKOH/g, and Tg of 61° C. The solution of the acrylic resin A had a heating residue of 36.0% by weight.

### Example 1

The prism sheet, the surface light source device, and the liquid crystal display device described in conjunction with FIGS. 1 to 3 were fabricated by the following manner.

For the transparent base 43, a 188-μm-thick PET film (from Toyobo Co., Ltd., with a trade name of A4300) was used. An acrylic resin having a refractive index of 1.49 (from Mitsubishi Rayon Co., Ltd., with a trade name of TF-8) was used as the transparent resin for constituting the light diffusion layer. TF-8 was dissolved in a mixed solvent of MEK (methyl ethyl ketone) and toluene (with a mixed ratio of 50% by weight each) to prepare a coating solution with a TF-8 concentration of 20% by weight. For the first light diffusing agent 452, silicone resin fine particles having a refractive index of 1.42, an average particle size of 3.0 μm, and an absolute specific gravity of 1.32 (from GE Toshiba Silicones Inc., with a trade name of Tospearl 130) were used. For the second light diffusing agent 454, acrylic resin fine particles having a refractive index of 1.49, an average particle size of 5.0 μm, and an absolute specific gravity of 1.20 (from Sekisui Plastics Co., Ltd., with a trade name of XX-495; 80% by volume of particles had particle sizes of 1 to 6 μm). The light diffusing agents 452 and 454 were added to the coating solution as much as 16.875% and 5.625% by weight with respect to the total solid content of the coating solution, respectively, so that the amount of addition of the first light diffusing agent was 75% by weight in ratio to the total amount of the diffusing agents added. The resultant was agitated and mixed to prepare a coating solution containing the light diffusing agents 452 and 454.

The coating solution was applied to the PET film by reverse gravure coating so as to have an average solvent-dry thickness of 6 pin, followed by drying. This formed a light diffusion layer having irregular structures of the light diffusing agents 452 and 454, i.e., an irregular surface, on one side of the PET film. The resulting film had excellent appearance with no production of uneven coating such as stripes.

In the light diffusion layer, the content ratio of the light diffusing agents having particle sizes of 1 to 4 μm with respect to the total amount of the light diffusing agents was 65.0% by volume, based on the ratios of the light diffusing agents added.

The light diffusion layer was loaded on a haze meter (from Nippon Denshoku Industries Co., Ltd., with a trade name of NDH 2000) with the light diffusion layer located on the light receiving side, and measured for total light transmission (JIS K 7316) Tt and haze (JIS K 7136) Haze. The result showed a total light transmittance of 95.8% and a haze of 67.0%. This haze value showed the total haze (H1+H2). To measure the internal haze H2 further, a transparent ultraviolet curing resin having a cured refractive index of 1.52 was spread over the light diffusion layer obtained. A 188-μm-thick PET film (from Toyobo Co., Ltd., with a trade name of A4100) was placed with its side having no adhesive coating on the ultraviolet curing resin, and an excess of the resin was squeezed off under a rubber roller. The resultant was irradiated with ultraviolet rays from the PET-film side for curing, and then the PET film was released. This formed a PET film having a smooth-surfaced light diffusion layer with an ultraviolet curing resin of 15 μm in cured thickness. The film was similarly measured for haze, which was 48.9%. This value showed the internal haze H2. The ratio of the internal haze to the total haze was therefore 73.0%.

The irregular surface of the light diffusion layer was measured for the average distance between local peaks S, the average distance Sm, and the ten-point average roughness Rz of the irregularities by using a surface roughness measuring instrument (from Tokyo Seimitsu Co., Ltd., with a trade name of Surfcom 1500DX-3DF) with a 1-μm probe (JIS B 0601-1994). The measurements were 18 μm in the average distance between local peaks S, 70.0 μm in the average distance Sm, and 2.9 μm in the ten-point average roughness Rz. The light diffusion layer was also checked for the state of aggregation of the light diffusing agents under an optical microscope (from Olympus Corporation, with a trade name of MX61L) at 500× magnification with transmitted light. The maximum number of secondary particles with a major axis diameter of 30 μm or greater that were found in a circular area of 70 μm in radius within any arbitrary area on the surface of the light diffusion layer was one.

A shape transfer surface having the configuration corresponding to that of the elongated prism formed surface was formed on the surface of a 1.0-mm-thick 400-mm-by-690-mm sheet of JIS brass Grade 3 to obtain a die member. The intended configuration of the elongated prism formed surface was such that a large number of elongated prisms 411 with a vertex angle θ=65° were arranged in parallel at a pitch P=50 μm.

A 220-mm-diameter 450-mm-long cylindrical roller of stainless steel was then prepared, around the outer periphery of which the die member was wound and fixed by screws to form a roll die. The transparent base having the light diffusion layer was fed to between the roll die and a rubber roller, along the roll die. The transparent base was nipped between the rubber roller and the roll die, using an air pressure cylinder connected with the rubber roller.

Meanwhile, an ultraviolet curing composition containing:

phenoxyethyl acrylate (Viscoat #192 from Osaka Organic Chemical Industry Ltd.): 50 weight parts,

bisphenol A-diepoxy-acrylate (Epoxy Ester 3000A from Kyoeisha Yushi Kagaku Kogyo Co., Ltd.): 50 weight parts, and

2-hydroxy-2-methyl-1-phenyl-propane-1-one (Darocure 1173 from Ciba-Geigy Ltd.): 1.5 weight parts,

was prepared to 300 mPa·S/25° C. in viscosity.

The ultraviolet curing composition was supplied onto the transparent base that was nipped between the rubber roller and the roll die, at a side opposite from where the light diffusion layer was formed. The roll die was rotated while the ultraviolet curing composition sandwiched between the roll die and the transparent base was irradiated with ultraviolet rays from an ultraviolet irradiation device. This polymerized and cured the ultraviolet curing composition to transfer the elongated prism pattern from the shape transfer surface of the roll die. The resultant was then released from the roll die to obtain a prism sheet.

The resulting prism sheet was cut into a 14.1 W (wide) size, and was placed on the light emission surface of a 14.1 W (wide)-size light guide made of acrylic resin, having a cold cathode tube on one end, with the elongated prism formed surface downward as shown in FIGS. 1 and 2. The other ends and the underside or back surface were covered with a reflecting sheet to complete a surface light source device. With the cold cathode tube turned on, the surface light source device was measured for normal luminance and half-value angle by using a luminance meter (from Topcon Corporation, with a trade name of BM-7). The result showed a normal luminance of 2905 Cd/m² and a half-value angle of 19.8°.

A transmission type liquid crystal panel was placed on the prism sheet of the surface light source device thus obtained. The liquid crystal panel was an XGA-pixel liquid crystal panel of 14.1 W (wide) size, having a 60° gloss value of 48.6 at the viewing surface and a 60° gloss value of 31.2 at the incident surface, measured by a gloss meter (from Nippon Denshoku Industries Co., Ltd., with a trade name of VGS-300A). The surface light source device was turned on and a white image was displayed on the liquid crystal panel to check the liquid crystal display for glare. Little glare phenomenon was observed, and viewable image quality was achieved with extremely smooth texture.

### Example 2

For a first light diffusing agent a, the silicone resin fine particles used in example 1, having a refractive index of 1.42, an average particle size of 3.0 μm, and an absolute specific gravity of 1.32 (from GE Toshiba Silicones Inc., with a trade name of Tospearl 130), were used. For a first light diffusing agent b, silicone resin fine particles having a refractive index of 1.42 and an average particle size of 4.5 μm (from GE Toshiba Silicones Inc., with a trade name of Tospearl 145) were used. The light diffusing agents were added to the coating solution as much as 15.75% and 6.75% by weight with respect to the total solid content of the coating solution, respectively, so that the amount of addition of the first light diffusing agent a was 70% by weight in ratio to the total amount of the diffusing agents added. The resultant was agitated and mixed to prepare a coating solution containing the light diffusing agents 452 and 454, and then a light diffusion layer was formed as in example 1. The resulting film had excellent appearance with no production of uneven coating such as stripes. Based on the ratios of the amounts of the light diffusing agents added, the amount of the light diffusing agents with particle sizes of 1 to 4 μm was 69.5% by volume with respect to the total amount of the light diffusing agents in the light diffusion layer.

The light diffusion layer obtained was measured for total light transmittance and haze as in example 1. The result showed a total light transmittance of 94.1%, a total haze of 66.3%, and an internal haze H2 of 57.9%. Therefore, the ratio of the internal haze to the total haze was 87.3%.

The irregular surface of the light diffusion layer was measured for the average distance between local peaks S, the average distance Sm, and the ten-point average roughness Rz of the irregularities as in example 1. The measurements were 18 μm in the average distance between local peaks S, 37 μm in the average distance Sm, and 2.5 μm in the ten-point average roughness Rz. The maximum number of secondary particles with a major axis diameter of 30 μm or greater that were found in a circular area of 70 μm in radius within any arbitrary area on the surface of the light diffusion layer was one.

An elongated prism formed layer was further formed to obtain a prism sheet as in example 1, and the prism sheet was used fabricate a surface light source device as in example 1. The surface light source device was measured for normal luminance and half-value angle as in example 1. The result showed a normal luminance of 2917 Cd/m² and a half-value angle of 19.1°.

Using the surface light source device, a liquid crystal display device was fabricated as in example 1. The liquid crystal display device was checked for glare as in example 1. Little glare phenomenon was observed, and viewable image quality was achieved with extremely smooth texture.

### Comparative Example 1

The light diffusing agents 452 and 454 used in example 1 were added to the coating solution as much as 5.625% and 16.875% by weight with respect to the total solid content of the coating solution, respectively, so that the amount of addition of the first light diffusing agent was 25% by weight in ratio to the total amount of the diffusing agents added. The resultant was agitated and mixed to prepare a coating solution containing the light diffusing agents 452 and 454. A light diffusion layer was formed by a manner otherwise the same as in example 1. Based on the ratios of the amounts of the light diffusing agents added, the ratio of the light diffusing agents with particle sizes of 1 to 4 μm was 21.6% by volume with respect to the total amount of the light diffusing agents in the light diffusion layer.

The light diffusion layer obtained was measured for total light transmission, total haze, and internal haze H2 as in example 1. The result showed a total light transmittance of 96.6% and a total haze of 79.3%. The internal haze H2 was 28.6%, and the ratio of the internal haze to the total haze was 36.1%.

The irregular surface of the light diffusion layer was measured for the average distance between local peaks S, the average distance Sm, and the ten-point average roughness Rz of the irregularities as in example 1. The measurements were 34 μM in the average distance between local peaks S, 81 μm in the average distance Sm, and 3.4 μm in the ten-point average roughness Rz.

An elongated prism formed layer was further formed to obtain a prism sheet as in example 1, and the prism sheet was used to fabricate a surface light source device as in example 1. The surface light source device was measured for normal luminance and half-value angle as in example 1. The result showed a normal luminance of 2650 Cd/m² and a half-value angle of 22.8°.

Using the surface light source device, a liquid crystal display device was fabricated as in example 1. The liquid crystal display device was checked for glare as in example 1. An extremely high glare phenomenon was observed with image quality of extremely poor viewability since the ratio of the internal haze to the total haze was as low as 36.1% and the volume ratio of the light diffusing agents with particle sizes of 1 to 4 μm was as low as 21.6%.

### Comparative Example 2

For the first light diffusing agent 452, the silicone resin fine particles used in example 1, having a refractive index of 1.42, an average particle size of 3.0 μm, and an absolute specific gravity of 1.32 (from GE Toshiba Silicones Inc., with a trade name of Tospearl 130), were used alone. The particles were added to the coating solution as much as 22.5% by weight with respect to the total solid content of the coating solution, and agitated and mixed to prepare a coating solution containing the light diffusing agent 452.

The light diffusion layer obtained was measured for total light transmission, total haze, and internal haze H2 as in example 1. The result showed a total light transmittance of 95.6% and a total haze of 73.6%. The internal haze H2 was 73.1%, and the ratio of the internal haze to the total haze was 99.3%. The light diffusion layer obtained was observed, and it was found that small stripe-like defects occurred in the direction of coating and the light diffusion layer had only poor appearance due to the single application of the first light diffusing agent 452.

Based on the ratios of the amounts of the light diffusing agents added, the ratio of the light diffusing agents with particle sizes of 1 to 4 μm was 88.4% by volume with respect to the total amount of the light diffusing agents in the light diffusion layer.

The irregular surface of the light diffusion layer was measured for the average distance between local peaks S, the average distance Sm, and the ten-point average roughness Rz of the irregularities as in example 1. The measurements were 19 μm in the average distance between local peaks S, 58 μm in the average distance Sm, and 1.3 μm in the ten-point average roughness Rz.

An elongated prism formed layer was further formed to obtain a prism sheet as in example 1, and the prism sheet was used to fabricate a surface light source device as in example 1. The surface light source device was measured for normal luminance and half-value angle as in example 1. The result showed a normal luminance of 2644 Cd/m² and a half-value angle of 20.1°.

The surface light source device dropped in normal luminance since the ratio of the internal haze to the total haze was as high as 99.3%.

### Example 3

In example 2, acrylic resin fine particles having a refractive index of 1.49, an average particle size of 10 μm, and an absolute specific gravity of 1.20 (from Sekisui Plastics Co., Ltd., with a trade name of XX-38B) were used as the third light diffusing agent 455. The first light diffusing agent a, the first light diffusing agent b, and the third light diffusing agent were added to the coating solution as much as 15.75%, 4.5%, and 2.25% by weight with respect to the total solid content of the coating solution, respectively, so that the amounts of addition were in ratios of 70%, 20%, and 10% by weight. The resultant was agitated and mixed to prepare a coating solution containing the light diffusing agents 452 and 455, and then a light diffusion layer was formed as in example 1. The resulting film had excellent appearance with no production of uneven coating such as stripes.

Based on the ratios of the amounts of the light diffusing agents added, the ratio of the light diffusing agents with particle sizes of 1 to 4 μm was 66.4% by volume with respect to the total amount of the light diffusing agents in the light diffusion layer. The third light diffusing agent per unit area of the light diffusion layer weighed 0.16 g/m².

The light diffusion layer obtained was measured for total light transmittance and haze as in example 1. The result showed a total light transmittance of 93.5%, a total haze of 67.6%, and an internal haze H2 of 56.0%. The ratio of the internal haze to the total haze was therefore 82.8%.

The irregular surface of the light diffusion layer was measured for the average distance between local peaks S, the average distance Sm, and the ten-point average roughness Rz of the irregularities as in example 1. The measurements were 26 μm in the average distance between local peaks S, 110 μm in the average distance Sm, and 3.4 μm in the ten-point average roughness Rz. The maximum number of secondary particles with a major axis diameter of 30 μm or greater that were found in a circular area of 70 μm in radius within any arbitrary area on the surface of the light diffusion layer was one.

An elongated prism formed layer was further formed to obtain a prism sheet as in example 1, and the prism sheet was used to fabricate a surface light source device as in example 1. The surface light source device was measured for normal luminance and half-value angle as in example 1. The result showed a normal luminance of 2892 Cd/m² and a half-value angle of 19.1°.

Using the surface light source device, a liquid crystal display device was fabricated as in example 1. The liquid crystal display device was checked for glare as in example 1. Little glare phenomenon was observed, and viewable image quality was achieved with extremely smooth texture.

The films obtained in examples 2 and 3, before the formation of the elongated prisms, were also evaluated for abrasion resistance by the following manner. Initially, a liquid crystal panel was placed on a horizontal stage with the side to make a contact with a light diffusion layer upward. A small piece of each film was placed thereon with the light diffusion layer downward. A double-sided adhesive paper tape (Nicetack NW-10 from Nichiban Co., Ltd.) was attached to the film piece at the side opposite from the light diffusion layer so as not to protrude laterally. A metal bar having a semicircular-shaped top with a radius of 5 mm was fixed to the film piece perpendicularly in the position where the double-sided tape was attached to the film piece. In this state, the bar was moved by 25 mm in a horizontal direction under a downward load of 25 g, causing friction between the surface of the liquid crystal panel and the light diffusion layer. The liquid crystal panel was the same as that used for luminance measurement, having fine asperities. The same test was also performed with another type of liquid crystal panel that had a multilayer polarizing mirror film (or dual brightness enhancement film?) (DBEF) attached thereto. The test was performed five times with different films and on different positions of each liquid crystal panel. Evaluations were made by visual inspection as follows:

⊚ . . . No flaw occurred in five tests.
◯ . . . A flaw occurred in only one of five tests. The flaw was not visible under transmitted light but only under reflected light.
Δ . . . Flaws occurred in two to five out of five tests. The flaws were only visible under reflected light.
x . . . A flaw (s) could be observed both under transmitted light and under reflected light, regardless of the number of times of flaws. With the liquid crystal panel of antiglare fine asperity type, the light diffusion layers were observed. With the DBEF panel, the DBEF was observed (no flaw occurred on the other side). Table 1 summarizes the evaluations.

TABLE 1

Type of liquid crystal panel surface

| | Fine asperity structure | DBEF |
|---|---|---|
| Example 2 | ◯ | ⊚ |
| Example 3 | ⊚ | ⊚ |

It was confirmed that the film of example 3 had an improved wear resistance against liquid crystal panels having a fine asperity structure as compared to the film of example 2.

### Example 4

In a vessel with 209 weight parts of the solution of the acrylic resin A obtained in manufacturing example 1, the following were measured: 5.7 weight parts of silicone resin fine particles having a refractive index of 1.42, an average particle size of 3.0 μm, and an absolute specific gravity of 1.32 (from GE Toshiba Silicones Inc., with a trade name of Tospearl 130) as a first light diffusing agent; 13.3 weight parts of acrylic resin fine particles having a refractive index of 1.49, an average particle size of 3.0 μm, and an absolute specific gravity of 1.20 (from Sekisui Plastics Co., Ltd., with a trade name of XX-57B; 99% by volume of particles had particle sizes of 1 to 6 μm) as a second light diffusing agent; 5.8 weight parts of Duranate TPA-100 from Asahi Kasei Chemicals Corporation as a crosslinking agent; and 49 weight parts of MEK and 74 weight parts of toluene as additional solvents. The resultant was agitated by a mixing impeller to prepare a coating solution for forming a light diffusion layer in which the light diffusing agents were distributed uniformly.

The coating solution had a solid content of 28% by weight, and the amount of addition of the light diffusing agents with respect to the total solid content was 19% by weight. The amount of addition of the first diffusing agent was 30% by weight in ratio to the total amount of the light diffusing agents added. MEK and toluene were in ratios of 40% and 60% by weight, respectively. The solid content of the acrylic resin A and the crosslinking agent were in ratios of 92.8% and 7.2% by weight, respectively.

The solution was then applied and dried as in example 1, except that the average solvent-dry thickness of the coating was 5 μm. The resulting film had excellent appearance with no production of uneven coating such as stripes. Based on the ratios of the amounts of the light diffusing agents added, the ratio of the light diffusing agents with particle sizes of 1 to 4 μm was 94.5% by volume with respect to the total amount of the light diffusing agents in the light diffusion layer.

The light diffusion layer obtained was measured for total light transmittance and haze as in example 1. The result showed a total light transmittance of 97.2%, a total haze of 66.6%, and an internal haze H2 of 15.6%. The ratio of the internal haze to the total haze was therefore 23.4%.

The irregular surface of the light diffusion layer was measured for the average distance between local peaks S, the average distance Sm, and the ten-point average roughness Rz of the irregularities as in example 1. The measurements were 18 μm in the average distance between local peaks S, 59 μm in the average distance Sm, and 2.0 μm in the ten-point average roughness Rz. The maximum number of secondary particles with a major axis diameter of 30 μm or greater that were found in a circular area of 70 μm in radius within any arbitrary area on the surface of the light diffusion layer was one.

An elongated prism formed layer was further formed to obtain a prism sheet as in example 1, and the prism sheet was used to fabricate a surface light source device as in example 1. The surface light source device was measured for normal luminance and half-value angle as in example 1. The result showed a normal luminance of 2922 Cd/m² and a half-value angle of 19.9°.

Using the surface light source device, a liquid crystal display device was fabricated as in example 1. The liquid crystal display device was checked for glare as in example 1. A slight glare phenomenon was observed, but with image quality with extremely smooth texture.

### Example 5

In example 4, silicone resin fine particles having a refractive index of 1.42, an average particle size of 3.0 μm, and an absolute specific gravity of 1.32 (from GE Toshiba Silicones Inc., with a trade name of Tospearl 130) were used as the first light diffusing agent. Acrylic resin fine particles having a refractive index of 1.49, an average particle size of 3.0 μm, and an absolute specific gravity of 1.20 (from Sekisui Plastics Co., Ltd., with a trade name of XX-57B) were used as the second light diffusing agent. The first and second light diffusing agents were added in ratios of 70% and 30% by weight, respectively, and a coating solution for forming a light diffusion layer was prepared as in example 4 so that: the coating solution had a total solid content of 28% by weight; the amount of addition of the light diffusing agents with respect to the total solid content was 21.7% by weight; MEK and toluene were in ratios of 40% and 60% by weight, respectively; and the solid content of the acrylic resin A and the crosslinking agent were in ratios of 92.8% and 7.2% by weight, respectively.

Next, the solution was applied to a film and dried under the same condition as in example 4. The resulting film had excellent appearance with no production of uneven coating such as stripes. Based on the ratios of the amounts of the light diffusing agents added, the ratio of the light diffusing agents with particle sizes of 1 to 4 μm was 91.1% by volume with respect to the total amount of the light diffusing agents in the light diffusion layer.

The light diffusion layer obtained was measured for total light transmittance and haze as in example 1. The result showed a total light transmittance of 94.2%, a total haze of 67.6%, and an internal haze H2 of 37.9%. The ratio of the internal haze to the total haze was therefore 56.1%.

The irregular surface of the light diffusion layer was measured for the average distance between local peaks S, the average distance Sm, and the ten-point average roughness Rz of the irregularities as in example 1. The measurements were 17 μm in the average distance between local peaks S, 41 μm in the average distance Sm, and 1.8 μm in the ten-point average roughness Rz. The maximum number of secondary particles with a major axis diameter of 30 μm or greater that were found in a circular area of 70 μm in radius within any arbitrary area on the surface of the light diffusion layer was one.

An elongated prism formed layer was further formed to obtain a prism sheet as in example 1, and the prism sheet was used to fabricate a surface light source device as in example 1. The surface light source device was measured for normal luminance and half-value angle as in example 1. The result showed a normal luminance of 2895 Cd/m² and a half-value angle of 19.7°.

Using the surface light source device, a liquid crystal display device was fabricated as in example 1. The liquid crystal display device was checked for glare as in example 1. Little glare phenomenon was observed, and viewable image quality was achieved with extremely smooth texture.

### Comparative Example 3

In example 5, acrylic resin fine particles having a refractive index of 1.49, an average particle size of 3.0 μm, and an absolute specific gravity of 1.20 (from Sekisui Plastics Co., Ltd., with a trade name of XX-57B) were used alone as a light diffusing agent. A coating solution for forming a light diffusion layer was prepared as in example 5 so that: the coating solution had a total solid content of 28% by weight; the amount of addition of the light diffusing agent with respect to the total solid content was 18.0% by weight; MEK and toluene were in ratios of 40% and 60% by weight, respectively; and the solid content of the acrylic resin A and the crosslinking agent were in ratios of 92.8% and 7.2% by weight, respectively.

Next, the solution was applied and dried under the same condition as in example 4. The resulting film had excellent appearance with no production of uneven coating such as stripes. Based on the ratios of the amounts of the light diffusing agents added, the ratio of the light diffusing agents with particle sizes of 1 to 4 μm was 96.9% by volume with respect to the total amount of the light diffusing agents in the light diffusion layer.

The light diffusion layer obtained was measured for total light transmittance and haze as in example 1. The result showed a total light transmittance of 96.7%, a total haze of 69.2%, and an internal haze H2 of 4.8%. The ratio of the internal haze to the total haze was therefore 6.9%.

The irregular surface of the light diffusion layer was measured for the average distance between local peaks S, the average distance Sm, and the ten-point average roughness Rz of the irregularities as in example 1. The measurements were 23 μm in the average distance between local peaks S, 50 μm in the average distance Sm, and 1.9 μm in the ten-point average roughness Rz. The maximum number of secondary particles with a major axis diameter of 30 μm or greater that were found in a circular area of 70 μm in radius within any arbitrary area on the surface of the light diffusion layer was one.

An elongated prism formed layer was further formed to obtain a prism sheet as in example 1, and the prism sheet was used to fabricate a surface light source device as in example 1. The surface light source device was measured for normal luminance and half-value angle as in example 1. The result showed a normal luminance of 2901 Cd/m² and a half-value angle of 20.3°.

Using the surface light source device, a liquid crystal display device was fabricated as in example 1. The liquid crystal display device was checked for glare as in example 1. A glare phenomenon of considerable intensity was observed with less viewable image quality since the ratio of the internal haze to the total haze was as low as 6.9%.

### Example 6

In example 4, acrylic resin fine particles having a refractive index of 1.49 and an average particle size of 10 μm (from Sekisui Plastics Co., Ltd., with a trade name of XX-38B) were also used as the third light diffusing agent. The first, second, and third light diffusing agents were added in ratios of 65%, 27%, and 8% by weight, respectively, and a coating solution for forming a light diffusion layer was prepared as in example 4 so that: the coating solution had a total solid content of 28% by weight; the amount of addition of the light diffusing agents with respect to the total solid content was 21.5% by weight; MEK and toluene were in ratios of 40% and 60% by weight, respectively; and the solid content of the acrylic resin A and the crosslinking agent were in ratios of 92.8% and 7.2% by weight, respectively.

Next, the solution was applied to a film and dried under the same condition as in example 4. The resulting film had excellent appearance with no production of uneven coating such as stripes. Based on the ratios of the amounts of the light diffusing agents added, the ratio of the light diffusing agents with particle sizes of 1 to 4 μm was 83.4% by volume with respect to the total amount of the diffusing agents in the light diffusion layer. The third light diffusing agent per unit area of the light diffusion layer weighed 0.10 g/m².

The light diffusion layer obtained was measured for total light transmittance and haze as in example 1. The result showed a total light transmittance of 93.7%, a total haze of 68.9%, and an internal haze H2 of 36.7%. The ratio of the internal haze to the total haze was therefore 53.3%.

The irregular surface of the light diffusion layer was measured for the average distance between local peaks S, the average distance Sm, and the ten-point average roughness Rz of the irregularities as in example 1. The measurements were 26 μm in the average distance between local peaks S, 77 μm in the average distance Sm, and 2.9 μm in the ten-point average roughness Rz. The maximum number of secondary particles with a major axis diameter of 30 μm or greater that were found in a circular area of 70 μm in radius within any arbitrary area on the surface of the light diffusion layer was one.

An elongated prism formed layer was further formed to obtain a prism sheet as in example 1, and the prism sheet was used to fabricate a surface light source device as in example 1. The surface light source device was measured for normal luminance and half-value angle as in example 1. The result showed a normal luminance of 2876 Cd/m² and a half-value angle of 19.7°.

Using the surface light source device, a liquid crystal display device was fabricated as in example 1. The liquid crystal display device as checked for glare as in example 1. Little glare phenomenon was observed, and viewable image quality was achieved with extremely smooth texture.

In addition, the film before the formation of elongated prisms was evaluated for abrasion resistance as in example 3. The result was favorable, no flaw being found in five tests with both liquid crystal panel surfaces of fine asperity structure and DBEF.

### Comparative Example 4

An amorphous polyester resin (from Toyobo Co., Ltd., with a trade name of Vylon 20SS, a solid content of 30% by weight, solvents of MEK/toluene=20%/80% by weight) was used as a transparent resin. Acrylic resin fine particles having a refractive index of 1.49, an average particle size of 4.5 μm, and an absolute specific gravity of 1.20 (Soken Chemical & Engineering Co., Ltd., with a trade name of Chemisnow MX-500) were used as a light diffusing agent. Xylylene diisocyanate (from Mitsui Chemicals Polyurethanes, Inc., with a trade name of Takenate 500) was used as a crosslinking agent. A coating solution for forming a light diffusion layer was prepared as in example 4 so that: the coating solution had a total solid content of 22% by weight; the amount of addition of the light diffusing agent with respect to the total solid content was 17.0% by weight; MEK and toluene were in ratios of 40% and 60% by weight, respectively; and the solid content of the acrylic resin A and the crosslinking agent were in ratios of 95.0% and 5.0% by weight, respectively.

Next, the solution was applied and dried to a coating thickness of 6 μm under the same condition as in example 1. The resulting film had uneven appearance with noticeable stripes as a whole. Based on the ratios of the amounts of the light diffusing agents added, the ratio of the light diffusing agents with particle sizes of 1 to 4 μm was 32.6% by volume with respect to the total amount of the light diffusing agents in the light diffusion layer.

The light diffusion layer obtained was measured for total light transmittance and haze as in example 1. The result showed a total light transmittance of 94.1%, a total haze of 58.2%, and an internal haze H2 of 33.3%. The ratio of the internal haze to the total haze was therefore 57.3%.

The irregular surface of the light diffusion layer was measured for the average distance between local peaks S, the average distance Sm, and the ten-point average roughness Rz of the irregularities as in example 1. The measurements were 43 μm in the average distance between local peaks S, 81 μm in the average distance Sm, and 4.2 μm in the ten-point average roughness Rz. The maximum number of secondary particles with a major axis diameter of 30 μm or greater that were found in an arbitrary circular area of 70 μm in radius within any arbitrary area on the surface of the light diffusion layer was five.

An elongated prism formed layer was further formed to obtain a prism sheet as in example 1, and the prism sheet was used to fabricate a surface light source device as in example 1. The surface light source device was measured for normal luminance and half-value angle as in example 1. The result showed a normal luminance of 3105 Cd/m² and a half-value angle of 17.9°.

Using the surface light source device, a liquid crystal display device was fabricated as in example 1. The liquid crystal display device was checked for glare as in example 1. An extremely high glare phenomenon was observed with image quality of extremely poor viewability since the average distance between local peaks S and the ten-point average roughness Rz were high and secondary particles were large in number.

### Comparative Example 5

The same combination of light diffusing agents as in example 6 were used. The first, second, and third light diffusing agents were added in ratios of 65%, 15%, and 20% by weight, respectively, and a coating solution for forming a light diffusion layer was prepared as in example 6 so that: the coating solution had a total solid content of 28% by weight; the amount of addition of the light diffusing agents with respect to the total solid content was 21.0% by weight; MEK and toluene were in ratios of 40% and 60% by weight, respectively; and the solid content of the acrylic resin A and the crosslinking agent were in ratios of 92.8% and 7.2% by weight, respectively. The solution was applied to a film and dried under the same condition as in example 6.

The resulting film had excellent appearance with no production of uneven coating such as stripes. Based on the ratios of the amounts of the light diffusing agents added, the ratio of the light diffusing agents with particle sizes of 1 to 4 μm was 71.1% by volume with respect to the total amount of the light diffusing agents in the light diffusion layer. The third light diffusing agent per unit area of the light diffusion layer weighed 0.26 g/m².

The light diffusion layer obtained was measured for total light transmittance and haze as in example 1. The result showed a total light transmittance of 93.7%, a total haze of 68.5%, and an internal haze H2 of 34.9%. The ratio of the internal haze to the total haze was therefore 51.0%.

The irregular surface of the light diffusion layer was measured for the average distance between local peaks S, the average distance Sm, and the ten-point average roughness Rz of the irregularities as in example 1. The measurements were 36 μm in the average distance between local peaks S, 177 μm in the average distance Sm, and 5.0 μm in the ten-point average roughness Rz. The maximum number of secondary particles with a major axis diameter of 30 μm or greater that were found in a circular area of 70 μm in radius within any arbitrary area on the surface of the light diffusion layer was one.

An elongated prism formed layer was further formed to obtain a prism sheet as in example 1, and the prism sheet was used to fabricate a surface light source device as in example 1. The surface light source device was measured for normal luminance and half-value angle as in example 1. The result showed a normal luminance of 2855 Cd/m² and a half-value angle of 19.6°.

Using the surface light source device, a liquid crystal display device was fabricated as in example 1. The liquid crystal display device was checked for glare as in example 1. A glare phenomenon of considerable intensity was observed with less viewable image quality since the amount of addition of the third light diffusing agent was as high as 0.26 g/cm² and Rz was as large as 5.0 μm.

Table 2 summarizes the results of the examples and comparative examples.

TABLE 2

| | | | | First light | First light | Volume | Second light | Third light | | Amount of |
|---|---|---|---|---|---|---|---|---|---|---|
| | | Volume ratio | | diffusing | diffusing | ratio of | diffusing | diffusing | | application |
| | Ratio of | of particles | | agent | agent b | first light | agent | agent | Third light | of third |
| | internal | with particle | | a (average | (average | diffusing | (average | (average | diffusing | light |
| | haze | sizes of | Binder | particle | particle | agent(s) | particle size | particle | agent | diffusing agent |
| | (%) | 1-4 μm (%) | resin | size [μm]) | size [μm]) | (a + b) (%) | [μm]) | size [μm]) | [weight %] | [g/m²] |
| Example 1 | 73.0 | 65 | acrylic | silicone 3 | — | 73.2 | acrylic 5 | — | — | — |
| Example 2 | 87.3 | 69.5 | ↑ | ↑ | silicone | 100 | — | — | — | — |
| | | | | | 4.5 | | | | | |
| Example 3 | 82.8 | 66.4 | ↑ | ↑ | silicone | 89.1 | — | 10 | 10 | 0.16 |
| | | | | | 4.5 | | | | | |
| Example 4 | 23.4 | 94.5 | ↑ | ↑ | — | 28 | acrylic 3 | — | — | — |
| Example 5 | 56.1 | 91.1 | ↑ | ↑ | — | 68 | ↑ | — | — | — |
| Example 6 | 53.3 | 83.4 | ↑ | ↑ | — | 62.8 | ↑ | 10 | 8 | 0.10 |
| Comparative | 36.1 | 21.6 | ↑ | ↑ | — | 23.3 | acrylic 5 | — | — | — |
| Example 1 | | | | | | | | | | |
| Comparative | 99.3 | 88.4 | ↑ | ↑ | — | 100 | — | — | — | — |
| Example 2 | | | | | | | | | | |
| Comparative | 6.9 | 96.9 | ↑ | — | — | 0 | acrylic 3 | — | — | — |
| Example 3 | | | | | | | | | | |
| Comparative | 57.3 | 32.6 | polyester | acrylic | — | 100 | — | — | — | — |
| Example 4 | | | | 4.5 | | | | | | |
| Comparative | 51.0 | 71.1 | acrylic | silicone 3 | — | 62.8 | acrylic 3 | 10 | 20 | 0.26 |
| Example 5 | | | | | | | | | | |

| | | | | | | | | Particle aggregation | | | |
|---|---|---|---|---|---|---|---|---|---|---|---|
| | | | | | | | | (number of particles) | | | |
| | | | | | | | | In arbitary area of | Abrasion resistance | | |
| | | | | | | | | 70 μm in radius | (LCD panel) | | |
| | | | | | | Half-value | | (major axis diameter | vs fine | | Coatability |
| | Total haze | Rz | S | Sm | Luminance | angle | Glare | of 30 μm or greater) | asperity | vs DBEF | good |
| Example 1 | 67.0 | 2.9 | 18 | 70 | 2905 | 19.8 | ⊚ | 1 max | not measured | not measured | good |
| Example 2 | 66.3 | 2.5 | 18 | 37 | 2917 | 19.1 | ⊚ | 1 max | ◯ | ⊚ | good |
| Example 3 | 67.6 | 3.4 | 26 | 110 | 2892 | 19.1 | ⊚ | 1 max | ⊚ | ⊚ | good |
| Example 4 | 66.6 | 2 | 18 | 59 | 2922 | 19.9 | ◯ | 1 max | not measured | not measured | good |
| Example 5 | 67.6 | 1.8 | 17 | 41 | 2895 | 19.7 | ⊚ | 1 max | not measured | not measured | good |
| Example 6 | 68.9 | 2.9 | 26 | 77 | 2876 | 19.7 | ⊚ | 1 max | ⊚ | ⊚ | good |
| Comparative | 79.3 | 3.4 | 34 | 81 | 2650 | 22.8 | X | not measured | not measured | not measured | good |
| Example 1 | | | | | | | | | | | |
| Comparative | 73.6 | 1.3 | 19 | 58.3 | 2644 | 20.1 | — | not measured | not measured | not measured | small stripe-like |
| Example 2 | | | | | | | | | | | defects |
| Comparative | 69.2 | 1.9 | 23 | 50 | 2901 | 20.3 | Δ | 1 max | not measured | not measured | good |
| Example 3 | | | | | | | | | | | |
| Comparative | 58.2 | 4.2 | 43 | 81 | 3105 | 17.9 | X | 5 max | not measured | not measured | stripe-like |
| Example 4 | | | | | | | | | | | defects |
| Comparative | 68.5 | 5.0 | 36 | 177 | 2855 | 19.6 | Δ | 1 max | not measured | not measured | good |
| Example 5 | | | | | | | | | | | |

Glare ◯: Hardly any X: Extremely high Δ: Moderate
Abrasion resistance ⊚: No flaw in five tests ⊚: A flaw in one of five tests

What is claimed is:

1. A lens sheet including a sheet-like transparent base that has a first surface and a second surface, a plurality of elongated lenses being formed in parallel on the first surface, a light diffusion layer made of transparent resin containing a light diffusing agent being formed on the second surface,
wherein the ratio of internal haze to total haze of the light diffusion layer is 20% to 90%, and the ratio of the amount of the light diffusing agent having particle sizes of 1 to 4 μm is 50% or higher by volume with respect to the total amount of the light diffusing agent.

2. The lens sheet as claimed in claim 1, wherein a first light diffusing agent that has a difference in refractive index Δn1 of greater than or equal to 0.03 and smaller than or equal to 0.10 from the transparent resin is contained as the light diffusing agent.

3. The lens sheet as claimed in claim 2, wherein the transparent resin and the first light diffusing agent are an acrylic resin and fine particles of a silicone resin, respectively.

4. The lens sheet as claimed in claim 2, wherein the ratio of the amount of the first light diffusing agent is 50% or higher by volume with respect to the total amount of light diffusing agents contained in the light diffusion layer.

5. The lens sheet as claimed in claim 1, wherein a second light diffusing agent that has a difference in refractive index Δn2 of lower than 0.03 from the transparent resin and has particle sizes of 1 to 6 μm is contained as the light diffusing agent.

6. The lens sheet as claimed in claim 1, wherein a third light diffusing agent that has particle sizes of 7 to 30 μm is contained as the light diffusing agent.

7. The lens sheet as claimed in claim 6, wherein the third light diffusing agent forms a protruding structure on the surface of the light diffusion layer, and the protruding structure protrudes in the range of 3 to 25 μm from a reference surface of the light diffusion layer.

8. The lens sheet as claimed in claim 1, wherein the total haze of the light diffusion layer is 50% to 85%.

9. The lens sheet as claimed in claim 1, wherein the surface of the light diffusion layer is formed as an irregular surface, and the irregular surface has an average distance between local peaks S of 40 μm or less and has a ten-point average roughness Rz of 4.0 μm or less.

10. A surface light source device comprising:
a primary light source;
a light guide that lets in, guides, and emits light emitted from the primary light source; and
the lens sheet as claimed in claim 1 that is arranged so that the light emitted from the light guide is incident thereon,
wherein the light guide has a light incident end surface for the light emitted from the primary light source to be incident on and a light emission surface for the guided light to be emitted from, the primary light source is arranged adjacent to the light incident end surface of the light guide, and the lens sheet is arranged so that the first surface faces the light emission surface of the light guide.

11. A liquid crystal display device comprising:
the surface light source device as claimed in claim 10; and
a liquid crystal panel that is arranged so that light emitted from the second surface of the lens sheet of the surface light source device is incident thereon,
wherein the liquid crystal panel has an incident surface for the light emitted from the second surface of the lens sheet to be incident on and a viewing surface on the opposite side.
